(19) United States
(12) Patent Application Publication
(10) Pub. No.: US 2015/0289093 A1
(43) Pub. Date: Oct. 8, 2015

(54) Social Network For Users Sharing Geolocation-Based Information

(71) Applicant: Ecom Enterprises, Inc., Sunnyvale, CA (US)

(72) Inventors: Raymond Petty, Sunnyvale, CA (US); Troy Shumaker, Sunnyvale, CA (US)

(73) Assignee: Ecom Enterprises, Inc., Sunnyvale, CA (US)

(21) Appl. No.: 14/244,810

(22) Filed: Apr. 3, 2014

(51) Int. Cl. H04W 4/02; H04L 12/58

(52) U.S. Cl. CPC H04W 4/021; H04L 51/36

(57) ABSTRACT

A social network enabling a plurality of users to post and access current information on a server related to topics of interest, where an information topic is referenced by a geolocation having a physical geographical location. There may be a plurality of geolocations that serve as contexts and references for organizing information related to different topics. A user establishes a certain geographic viewing area and view and access geolocations within that area. Generally, a user may access a geolocation without regard to the user's location, although some geolocations may be restricted and require the user to have certain attributes or a certain location for access.

### BACKGROUND

This invention relates generally to social networks, and more particularly to social networking systems and methods that enable persons who are connected by geolocation-based points of interest to interact and communicate among themselves.

The explosive growth of mobile communications devices such as smartphones, tablets, and portable computers embodying processors and that are capable of accessing the World Wide Web (the “Internet”) has opened vast new possibilities for people to access and communicate information on line. It has also contributed significantly to an expansion of social networking to the mobile environment, which, in turn, has fueled the explosive growth in mobile communications even more. The attractiveness of social networking services is that they provide platforms that allow users to build social networks or relations among those who share common interests, activities, backgrounds or other connections. Today's fast-paced societies demand rapid access to information and interconnectiveness that are characteristic of mobile on line networking services. In fact, many social networking services owe their existence to the mobile environment.

There are many well-known social networking services. A prominent one is Facebook which is an online social networking service. Users must register before using the service, after which they may add other registered users as “friends” with whom they can exchange messages. Users may additionally join, and interest user groups which are organized by, for example, workplace, such as school or college, or some other characteristic, and they may categorize their friends into lists based upon their associations. Another prominent online social networking and microblogging service is Twitter that enables registered users to send and read short 140-character text messages called “tweets”. Tweets by default are publicly visible, although senders may restrict message delivery to just their “followers”. Twitter involves the principle of followers, by which users may subscribe to other users' tweets as followers. Unless restricted, unregistered users may be able to read the publicly available tweets, but they must be registered to send tweets.

A drawback of many social networking services is that users must be registered with a service or otherwise be a member of a designated group in order to fully participate in and take full advantage of the service. Most social networking services have established centrally administered policies that prescribe the information that all users must provide in order to granted full access, and failure to comply will prevent a user from becoming a registered user of the service. Many users would prefer not to have to register with a service or be required to divulge personal private information about themselves in order to be granted privileges to use the service. Another drawback of some location-based social networks is that they require that a user be at a particular location or be within a particular area to receive and communicate information.

Many users would like to be able to associate themselves voluntarily and transiently with a social network to obtain and communicate information about a subject of interest that is particularized, specific, and non-personal, without the necessity of physically being at a particular location or within a particular area or possessing some other attribute, such as membership in a group. The desired information may be limited to a specific subject or topic of current real-time interest to the user, and may additionally be associated with a particular location. For instance, a tourist may be interested in events going on or points of interest within a particular area of a city. Alternatively, one wishing to attend an event at a particular locality may be interested in real-time information on ticket availability, crowds, or traffic conditions in the vicinity of the event location. Known social networks are not optimized for such purposes or for providing information having a current context or relevance to a particular location.

It is desirable to provide social networking systems and methods that address the foregoing and other problems with known social networking services, and it is to these ends that the invention is directed.

### SUMMARY OF THE INVENTION

The invention provides systems and methods that in their broadest aspects afford social networks that permit individual users to create references that provide contexts or focal points for communicating or receiving timely information related to a topic of interest to or from a server, without requiring the users to “friend” or “follow” other users, and without requiring that the users be members of a particular group or have a predetermined attribute. Unlike other social networks that rely on a user's relationships with other users to create a connection and communicate, in a system and method in accordance with the invention communications relevant to a topic of interest are with a server and are facilitated using physical focal or reference points to relate the communications. In a preferred aspect, the focal points that constitute the references for topics of interest comprise geolocations (physical geographical points or things of interest). Users that wish to communicate or receive information relevant to a topic of interest do so via posts with a server and use a geolocation as a reference for the communications. Users may access that geolocation as desired to post and receive information from the server without the necessity of being at or near that geolocation. In another aspect, users may have access by default because of their own locations.

Accessible geolocations may be defined as physical locations at or in proximity to a particular location, thing or point of interest. Generally, in a preferred aspect, geolocations may be publicly accessible by users without regard to a user's actual location. Geolocations accessible by a user may be those in an area relative to a location selected by a user. In still other aspects, accessible geolocations may determined by particular features, characteristics or relationships of the user to the geolocation. For instance, access may be based upon a user's actual location, or on privileges granted to the user by the creator of the geolocation based upon the user's identity or other attributes.

Generally, the invention affords computer-implemented methods and computer readable media for methods where a geolocation that forms a reference for information related to the geolocation and to a topic of interest, and has a physical geographical location is created using geolocation data that includes geographical coordinates that define the physical location and user access privileges to the geolocation. A user can display on a user device, which may be mobile, geolocations within a user-defined area to which the user has access privileges, and may access a selected geolocation without the necessity of the user having a predetermined location.

### BRIEF DESCRIPTION OF THE DRAWINGS

FIG. 1 is an overview of a network system in which the invention may be used;

FIG. 2 illustrates a map view that may be displayed on a user's device in accordance with a first embodiment of the invention, the figure showing a first way in which the invention may operate to provide accessible geolocations in a predetermined area about a current location of the user;

FIG. 3 illustrates another map view that may be displayed on a user's device in accordance with a second embodiment of the invention, the figure showing another way in which the invention may provide accessible geolocations in an area about a location selected by the user;

FIG. 4 is a diagrammatic overview of a workflow process in accordance with the invention by which a user's location is used to select geolocations for display on the user's mobile device;

FIG. 5 is a diagrammatic view of a workflow process in accordance with the invention by which a user selects a geolocation and displays geolocation data;

FIG. 6 is a diagrammatic view of a workflow process for retrieving and presenting geolocations to a user;

FIG. 7 is a diagrammatic view of a workflow process in accordance with the invention by which a user may create a geolocation; and

FIG. 8 is a diagrammatic view is a diagrammatic view of a server workflow process in accordance with the invention by which a user may create information posts that reference a geolocation.

### DESCRIPTION OF PREFERRED EMBODIMENTS

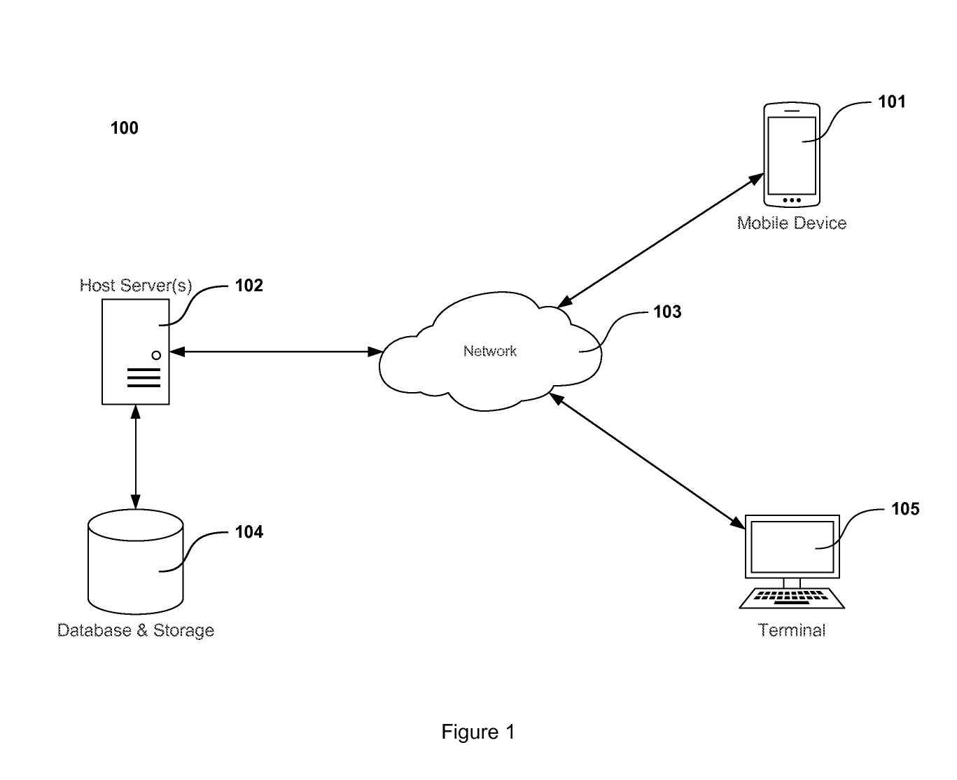

FIG. 1 illustrates an embodiment of a system 100 that may form a social network and may be used to practice the invention. As shown, the system may comprise one or more computer servers 102 connected by a network 103 to one or more processor-enabled mobile devices 101, such as smartphones, tablets or portable computers, and/or to one or more fixed computing devices 105 that are capable of transmitting and receiving information over the network with server 102. Network 103 may be a wired network, a wireless network or a combination of both wired and wireless networks. Preferably, it is connected to the World Wide Web (Internet), and server 102 hosts a website as a central point for communications for the social network. Server 102 may have associated physical non-transitory storage media, such internal memory and one or more external disks 104, that store data and instructions that control the computer server to perform the operations described herein, and that store information communicated by users. Mobile device 101 and computer 105 may similarly embody physical non-transitory storage media for storing instructions including software applications (“apps”) that control their internal processors to perform operations as described herein. While the invention may be used with fixed computer devices, it is particularly well adapted for use with mobile devices and will be described in that context. It will be appreciated, however, that the invention is also applicable to fixed computers, and has utility with other devices and in many other contexts.

As will be described more fully below, the system 100 in an embodiment may be formed to provide a social network that allows users of mobile devices and terminals to communicate information with the server by reference to one or more “geolocations”. As used herein, the term “geolocation” refers to a physical, geographic location or point of interest in the world that may be defined by geographical coordinates of latitude and longitude. A geolocation is a common focal point or a point of reference for information and communications posted by users that is related to topics of interest. In effect, a geolocation comprises a common element for organizing information and for communicating about a topic. The information communicated may be in the form of text such as posts, comments, reviews, etc., or in the form of images such as photos or video, or in the form of audio. Although the geolocation may refer to a physical location or point of interest, the information communicated need not be about the particular geolocation or point of interest, although it often may be. The information may be about any topic. Geolocations may be created by individual users (acting as creators) based upon a creator's particular geographical location at the time the geolocation is created or upon some other arbitrary geographical location, as will be described. The creator of a geolocation may establish restrictions that prescribe access privileges to the geolocation by other users. Different restrictions may apply to the privilege to view and read posted information and the privilege to post information. In some embodiments of the invention, access to a geolocation may be restricted to users having an actual or designated location within a predetermined geographical area, or to users that meet certain criteria or characteristics, or that have certain attributes such as membership in a class or group. In other embodiments, a creator may choose not to restrict access to a geolocation so that it is public and accessible by any user. In still other embodiments, a geolocation may be public to view information, but private and restricted as to the ability to post information to it.

At times herein, this description for succinctness may refer to “accessing” a geolocation or to posting or viewing or communicating “to”, “through” or “at” a geolocation. It is to be understood, however, that this not to be taken literally, but is merely a shorthand way of describing that a geolocation is a context or a reference for information communicated to or accessed from the server. A geolocation may, at times, be formed to restrict the users who have access to such information.

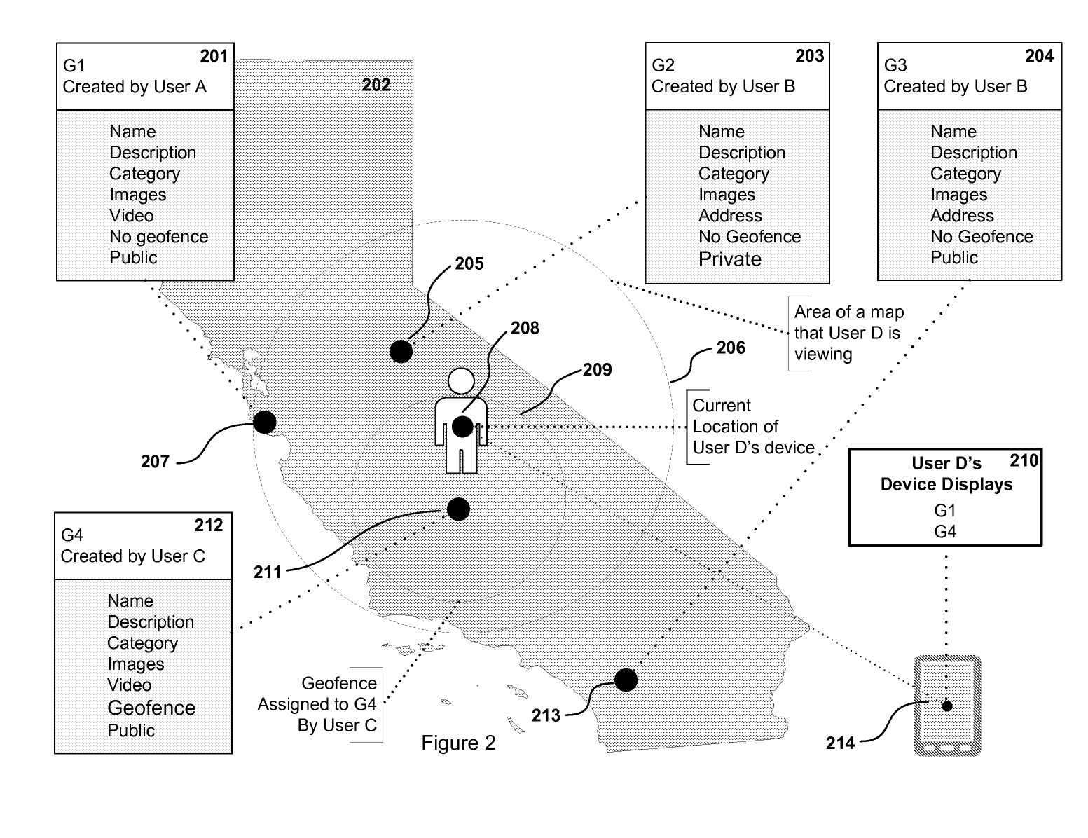

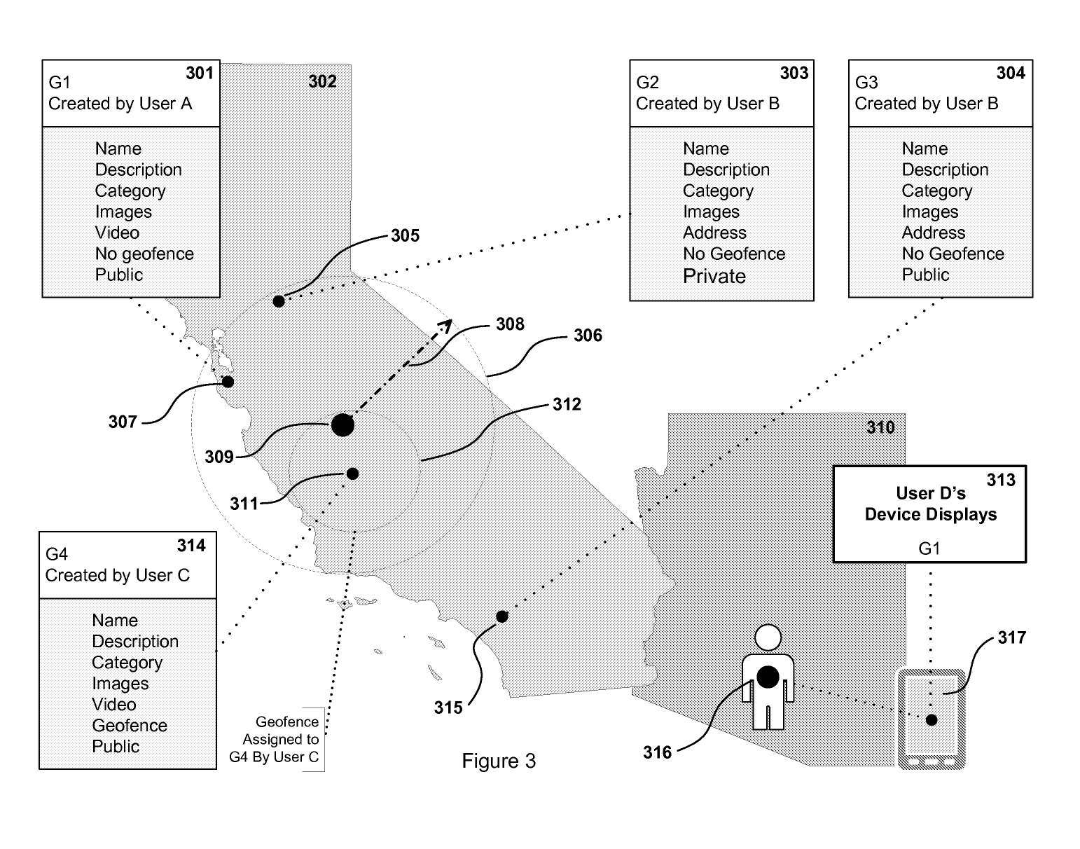

FIGS. 2 and 3 are similar map views that illustrate different embodiments of the invention and different ways in which the invention may be used. As will be appreciated, these embodiments are not mutually exclusive and may be used selectively together or for different users.

When a user logs in to the server (social network), the user may initially be presented on his mobile device or computer with a map view that displays a particular geographical region and accessible geolocations within that region. The geolocations returned by the system may also be displayed in a list view, filtered by category or interest, and searched using keywords. The system may also display geolocations by their trending (activity) status. The initial geographical area (location and size) displayed may be set by default or by user preferences. Initially, the default area may be defined by a predetermined radius, e.g., a mile, about the user's current location, be the user's last area viewed, or be a preselected area and location stored in the user's preferences for initial display settings in the database. Accordingly, the user's device is preferably GPS enabled or otherwise has the capability of automatically determining its location using cellular/WiFi triangulation or other technologies, and can report its location back to the server. FIG. 2 illustrates a map view based upon a user's current location. Alternatively, in a preferred embodiment, the system may present a map view of accessible geolocations in an area based upon a location selected by the user that is different from the user's actual current location. FIG. 3 illustrates such a map view. In either case, a user may zoom in or out and pan the displayed area to different locations, as by using known conventionally available Internet map applications.

FIG. 2 illustrates a map view of a large geographical area 202, such the state of California, in which there may be four geolocations, G1 (207), G2 (205), G3 (211) and G4 (213) created by users A, B and C. User B may be the creator of both G2 (205) and G3 (213), as indicated. The figure shows that a user D (at 208) has zoomed the area displayed on his mobile device 214 to define a viewing region bounded by the dotted circle 206 that is centered on the user's current location 208. As shown, geolocation G3 (213) is outside of the region 206 displayed on user D's device 214, but within the larger geographical area 202, and therefore will not appear on the user's display. However, geolocations G1 (207), G2 (205), and G4 (211) are within the user's selected viewing area 206. Whether these geolocations will be displayed on user D's device 214 depends upon their restrictions.

A creator of a geolocation may establish a corresponding set of attributes and restrictions applicable to that geolocation, and store them in the database 104. These are shown at 201, 203, 204 and 212 for the four geolocations G1-G4, respectively. As indicated, attributes for a geolocation may comprise, among other things, a name, a description, a category, an image and or a video, an address of the geolocation, etc. Restrictions may include, for instance, classifying a geolocation as “public” or “private”, as well as surrounding the geolocation with a “geofence” defining a geographical area of restriction. A geolocation designated as “private”, such as G2 (205), means that in order to access the geolocation, a user must first be granted permission by the creator. For example, for user D to access geolocation G2 (205), user D must be within a category identified by the creator (user B) as being authorized, such as by being specially identified, by having a certain status, e.g., being family or a friend of the creator, or by being a member of another designated group. A geofence is a boundary that defines a predetermined region or area about a geolocation established by the creator of the geolocation. The creator of a geolocation may use the area bounded by the geofence to place restrictions on access to the geolocation. For example, a geolocation such as G4 (211) that has a geofence may mean that as a condition for accessing the geolocation, a user must have a “location” within the preset area about the geolocation defined by the geofence. The restriction may require either that the “location” of the user be an actual location within the area or, alternatively, only be a designated location within the area. Thus, with a geofence restriction, the server must first determine a user's actual or designated location, as appropriate, before granting the user access to the geolocation.

As shown in FIG. 2, geolocation G4 (211) has a geofence 209 about it, as indicated by the dotted circle. Since user D's location at 208 is within the geofence 209, user D may be granted access to geolocation G4, in which case the location of G4 will be displayed on the map view of user D's mobile device 214, as indicated at 210. Additionally, since geolocation G1 (207) is within the area 206 selected by user D for display on user D's device 214, and G1 is public (unrestricted access), the location of G1 (207) will also be displayed on user D's device, as indicated at 210. Although geolocation G2 (205) is also within the display area 206 of user D, G2 is restricted as “private”. Assuming that user D does not fall within an authorized category, user D cannot access G2 (205). Thus, G2 will not be displayed on user D's device 214.

In alternative embodiments, other restrictions on a geolocation may be defined such that a user that is not within a predetermined area about or a prescribed distance from a geolocation may, nevertheless, access and view information and posts by other users, but may be prohibited from posting information about the geolocation. Flexible restrictions and privileges may be defined also for geolocations that are designated as being private. Some users may be granted privileges to view information posted by other users while being restricted from posting information themselves. In some embodiments, a user may be able to view information at a restricted geolocation, but be restricted from posting information to the geolocation. Restrictions and privileges may also be defined based upon other criteria.

FIG. 3 illustrates a map view similar to FIG. 2 that illustrates an alternative embodiment of the invention. In the embodiment of FIG. 3, a user D located at 316 in an area 310 that is remote from area 302 may manually designate, as with his mobile device 317, a location 309 within area 302 as a center point for defining a viewing (display) area 306. As described above in connection with FIG. 2, the area 302 may include a number of geolocations G1-G4 (307, 305, 315 and 311 and user D may have defined a viewing area of interest as the dotted circular area 306 centered at 309 with a radius 308. In this case, user D may view the geolocations located within the selected display area 306 unless they are restricted. Assuming there are geolocations G1-G4 (307, 305, 315 and 311) in area 302, as shown, and that they have the same restrictions as previously described for FIG. 2, user D may access and display on his device 317 information referenced by geolocation G1 (307) since it is public, within the selected display area of interest 306, and has no geofence, as shown at 313. Thus, user D's remote location 316 is not a prohibition to access of G1. On the other hand, while geolocations G2 (305) and G4 (311) are also encompassed within the area 306 about designated location 309, G2 is marked private and G4 has a geofence defining a region 312 that does not encompass user D's remote location 316. For this embodiment, it is assumed that the geofence restriction of G4 is the same as described for FIG. 2, requiring the user to have an actual location within the geofence to access it. Thus, neither geolocation G2 nor geolocation G4 will be accessible by user D and neither will be displayed on user D's device 317, as indicated at 313.

As described above, the embodiment of FIG. 3 may, as an alternative, allow a user such as D to post information to a geolocation such as G4 having a geofence 312 based upon the user's manually entered location, such as D's designated location 309, rather than the user's actual location 315. This would, for instance, be selectable as an option by the creator of the geolocation. In this event, the alternative embodiment of FIG. 3 becomes substantially the same as described above for FIG. 2.

Having described above an overview of the operation of the invention and several of its embodiments, the following will describe in more detail operational workflows that may be employed for implementing the invention.

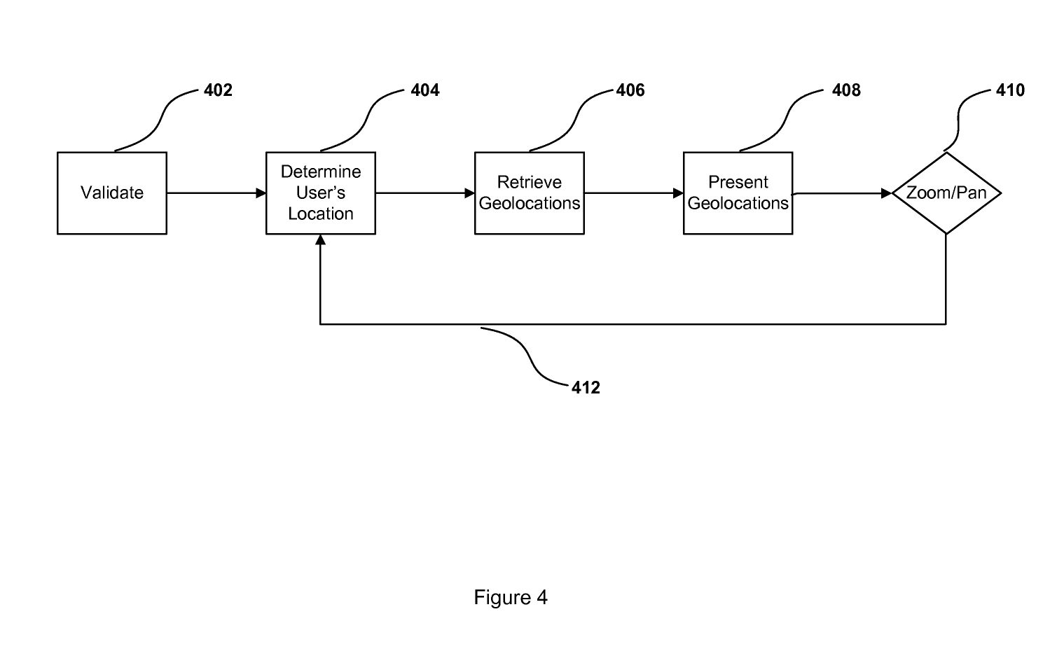

FIG. 4 illustrates a workflow in accordance with an embodiment of the invention for determining a user's location and for displaying geolocations accessible to the user. Referring to the figure, upon a user logging in to the social network and being validated as indicated at 402, the user's location may be determined at 404, as by the server querying the user's device. This may be the actual geographic location of the user's device, as determined using a GPS module in the user's device, or by cellular/WiFi triangulation, or other mapping and locating technology, or it may be a location designated by the user that is remote from the user's actual physical location, as described above. The designated location may be supplied to the server as part of the user's login information. By default, the system may use the user's actual geographical location rather than a designated location. In either case, the location may be sent automatically from the user's device to the server which uses information as a basis for determining geolocations accessible to the user. At 406, the server 102 may query the database 104 and retrieve accessible geolocations meeting specific criteria, such as proximity to the user's actual or designated location by being within a predefined geographical display area that is set by the user, or that is in a category of interest defined by the user. The display area may be a default area established by the system about the user's location; it may be an area having a location and size preselected by the user and stored in a user profile at the server; or it may be the last area viewed by the user. At 408, the server may retrieve and display accessible geolocations on a map view such as shown in FIG. 2 or 3 on the user's device. The geolocations that are accessible to the user may be those that meet the specific criteria, such as being based upon the user's location, the default or preselected viewing (display) area, and the restrictions, if any, established by the creators of the geolocations. At 410, the user may zoom or pan the map area displayed on the use's device to a different size and/or to a different location. The user's location information may be fed back at 412 to step 404, and the workflow process may be repeated to retrieve and present geolocations based upon the zoomed and panned map display.

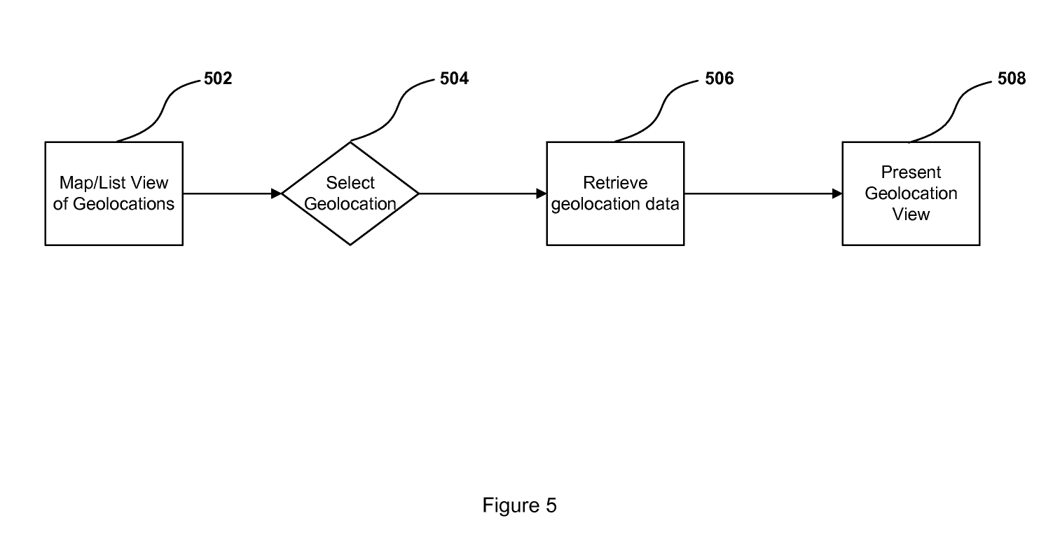

FIG. 5 illustrates an embodiment of a workflow process for the selection of a geolocation by a user and the viewing of the geolocation's associated information. At step 502, a user displays on his mobile device either a map or list view of accessible geolocations, such as was described, for example, in workflow step 406 of FIG. 4. Accessible geolocations may be determined based upon the user's current location, or upon another location designated by the user, as described above. At 504, the user may select one of the displayed geolocations of interest, and transmit to the server a request for information associated with geolocation, along with the user's credentials and an identification of the geolocation. At step 506, the server, using the information received from the user, may retrieve the data associated with the selected geolocation, and at step 508 present the retrieved data to the user for display on the user's device. The geolocation data may comprise, for instance, previous posts, comments, reviews, images, videos, audio, etc., from other users. The data presented to the requesting user may be in reverse chronological order so that the most recent postings are listed first. Using his display device, the user may respond to any of the displayed communications of other users by posting his own comments to the server for that geolocation, as will be described.

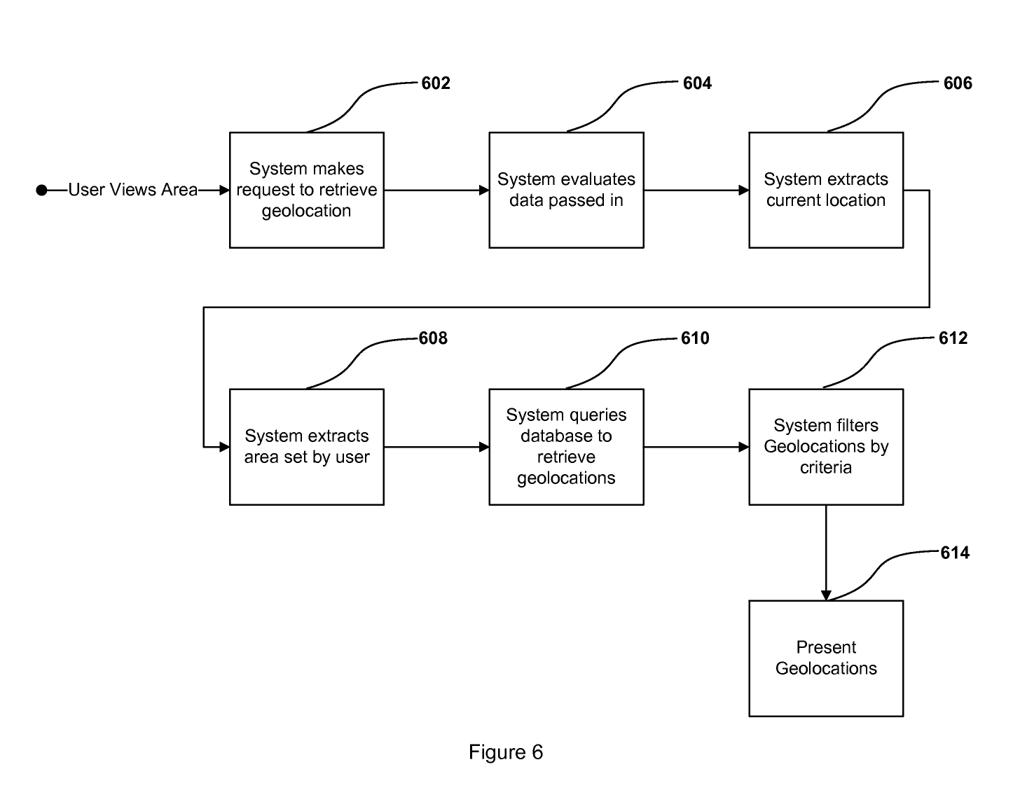

FIG. 6 illustrates an embodiment of a preferred workflow process in accordance with the invention for responding to user requests to retrieve geolocations and for presenting the geolocations to the user. At step 602 of the workflow process, the server may receive a request from a user to retrieve geolocations in a specific area. The request to the server may be sent from the user's device and may include several data points, including, for example, the user's credentials, the user's current location and area of interest, and any categories of interest to the user that the server may use to filter the information associated with the geolocations that are presented to the user. As will be described in more detail, the user's request for access may include search parameters related to topics of interest. The server may use these parameters to search the database and filter the response to the user's request. At step 604, the server may process and parse the data received as part of the request to establish specific parameters that will be used to retrieve geolocations and respond to the request. At step 606, the system may extract the user's current location or another location designated by the user based upon the data parsed from the request for responding to the request. As a default, the current location of the user may be used. At step 608, the workflow process may extract the geographical area of interest set by the user. Next at step 610 of the workflow, the server may generate a query of the database to retrieve all geolocations that meet the specific criteria set by the user in the user's request including, for example, the area of interest, the category of interest, and the user's credentials. At step 612 of the workflow process, the server may query the database, filter the geolocations returned in response to the query based upon the criteria set by the user and the restrictions established by the creators of the geolocations, which may include a geofence and privacy settings, for example. The server may further filter the search results using other information or criteria in the request, or filter the results based upon the user's identity, to refine the final results returned to the user. At step 614 of the workflow process, the final data set comprising the filtered geolocations identified in response to the request may be presented to the user on the user's mobile device. The identified geolocations may be displayed on the user's device on a map view, in a sorted order in a list view, or in some other manner, for example.

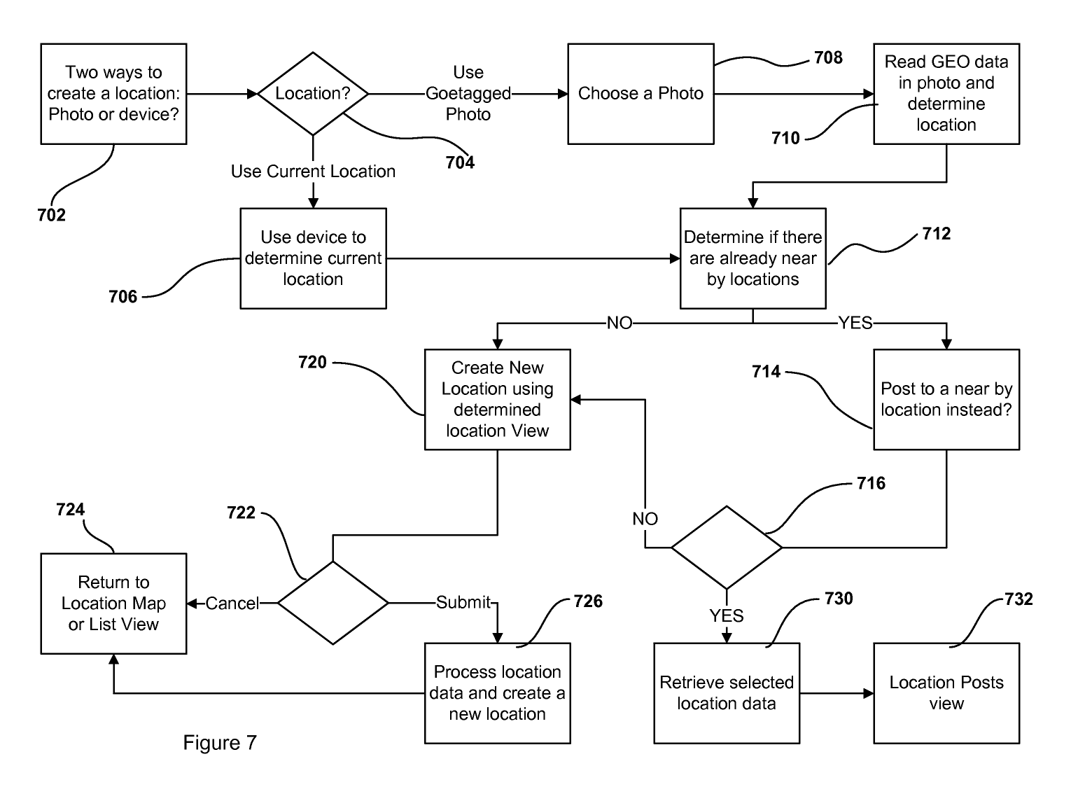

FIG. 7 illustrates a preferred embodiment of a workflow process in accordance with the invention by which a user may create a new geolocation and establish restrictions for that geolocation. A new geolocation is established by first selecting a particular geographic location (longitude and latitude coordinates, for example) for the new geolocation. The geographic location may be selected in a number of different ways. It may be selected, for example, by using the creator's current location as determined by the creator's mobile device, by using a location identified by the geo-tag data in a geo-tagged photograph, by manually inputting geographical coordinates of the new geolocation, by using the location of a well-known point of interest, or by using the location of a previously established geolocation, among others.

Referring to FIG. 7, at step 702 of the workflow process a user/creator first creates a location for the new geolocation. This may be done at step 704 by using the geolocation creator's current location as determined at 706 by the creator's mobile device from GPS data, triangulation, or other means as previously described, or by manually entering the geographical location data directly using the user's mobile device. Alternatively, as described above, the location data may be input into the system by reading geographical coordinates from a geo-tagged image such as a photograph, as indicated at 708-710. The geographical coordinates should comprise latitude and longitude. Elevation or altitude is not necessary but may also be included. Next, at step 712 of the workflow, after the server has received valid geographical location data, it may determine if there are already geolocations in the immediate area indicated by the received location data and alert the creator. It is possible that another user has already created a geolocation at the same point or a nearby location as the new geolocation being created. Additionally, the creator may have incorrectly entered location data for the new geolocation. The alert gives the creator the option to use a previously created geolocation, or to continue with the creation of the new one.

In the event the system determines at step 712 that there is a nearby location already created, it will be identified to the creator at step 714 and the creator given the option at 716 to proceed with the creation of the new location or to accept the previously created location. Assuming that the creator determines at step 716 not to proceed with the creation of the new location, or otherwise the system determines at step 712 that there are no nearby locations, at step 720 the user may proceed to create the new geolocation using the geographical location determined at steps 706 or 710. If the creator determines at step 722 to cancel the creation process, at step 724 the creator may be returned to the location map or map view display. Otherwise, if the creator determines at 722 to go forward with the creation process, at step 726 the system creates the new geolocation. This requires that the creator input at step 726 certain data, such as a name, description, category/interest, an image, etc., as well as any restrictions such as a geofence or restricted access that the creator may wish to establish for the new geolocation. Once the creator has input all of the information required for the new geolocation and processing of the information has been completed complete, the system will create the new geolocation and make it available to other users of the system based upon the restriction parameters set by the creator.

If, at step 716, the creator determines to go forward with creating a new geolocation by using the location data of a previously created geolocation, at step 730 the server retrieves the location information from the database for the previously created geolocation, and may take the user to that location by displaying it on his mobile device. A creator may choose to create the new geolocation at the location of the previously created geolocation because of a different point of interest located proximately to the previously created geolocation. This illustrates that it is not the geographical location, per se, of a geolocation that serves as the focal point or reference for communications. At step 732 of the workflow, the system may present the creator with the nearby location that was selected at step 714 to allow the user to freely access the previously created geolocation and communicate into it via posts, comments, reviews, ratings, images, etc., based upon any restrictions on the previously created geolocation that were established by the user that created it.

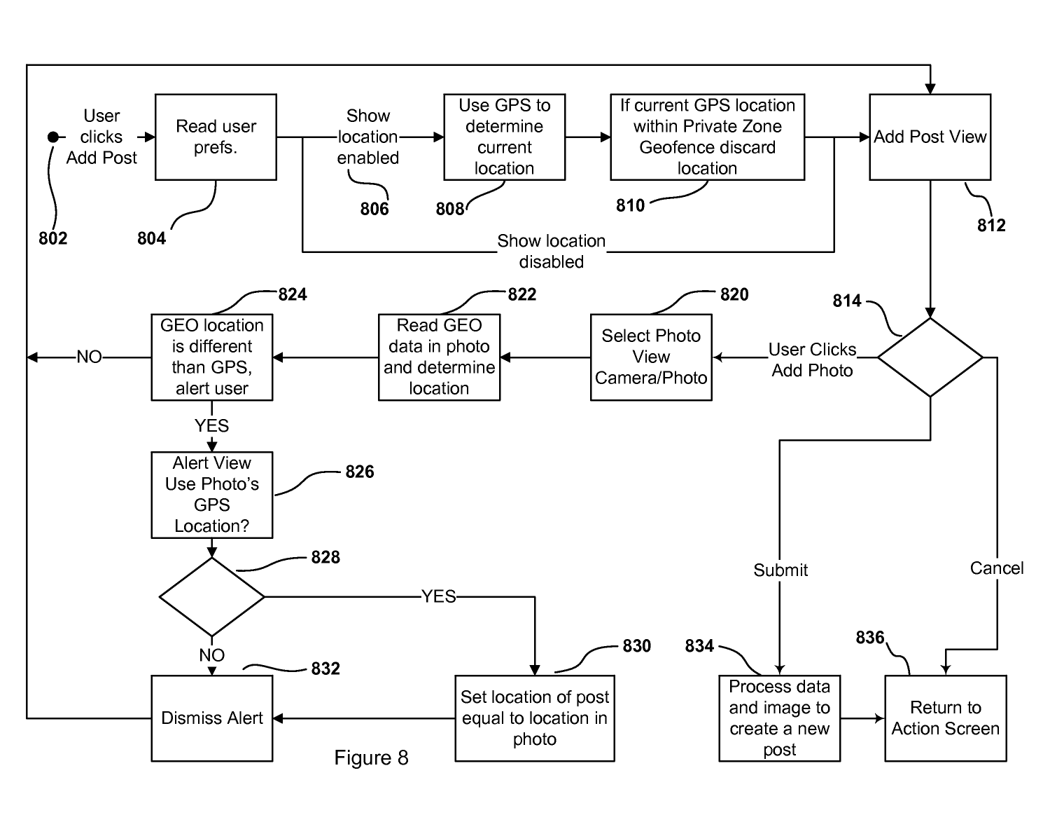

FIG. 8 illustrates a workflow process in accordance with the invention by which a user may post, i.e., communicate, information to the server using a selected geolocation as a reference. The information posted to a geolocation may be on any topic, although typically the information would relate in some way to the geolocation. For example, a post may include a question about something of interest in the vicinity of the geolocation, be a response to another user's post, or be information in the form of a text message, image, video, audio or a combination thereof. A significant advantage of the invention is that it may be used to obtain real-time information about something of interest at or near a geolocation, such as, for example, current snow conditions at a particular skiing location, fishing conditions at a particular fishing location, or traffic conditions in the vicinity of a ball game.

The posting process starts at step 802 with the user determining to add a post to a geolocation. At step 804, the server may read the user's preferences from a profile of the user stored in the database. The preferences they comprise various predetermined settings that the user has previously decided to apply to his interactions with the network. These settings may comprise, for instance, settings to control or restrict information about the user to protect the user's privacy, such as, for instance, whether the user wishes to share his current location when he creates a post to a geolocation. If, as shown at step 806, the user's preference is to show his location, the server must be capable of determining the user's geographic location. As previously described this may be done using a GPS module, cellular/WiFi triangulation, or other similar mapping technologies, and may include manual entry by the user of his geographical location. At step 808, the system determines the user's current location, and at step 810 whether the user is within a private zone or a geofence. The system may automatically prevent the user's current location from being stored, as it could possibly divulge information about a restricted geolocation. If, instead, the user's current location is determined to be outside of the predetermined limits of the private zone, the system may allow the user's current location to be stored along with the information of the post created by the user. At step 812, the system may present a screen (display) that allows the user to create an information post to the geolocation. Using this display, the user may create a post comprising, for instance, a text message, and the have the option to select the media to upload to the server as part of the post. The media may comprise images, video, or audio, as well as the user's current location if the user's preferences and his mobile device permit this.

If the user decides at 814 to add media to his post, at step 820 the system may provide an interface to the user that enables the user to select desired media on his device to upload with his post. This requires that the user's device be capable of providing such media, as by storing it locally, in order for this option to be available. Upon the user selecting the media at step 820, such as a geo-tagged photograph, at step 822 the system may read the geo-tag data from the photo and determine the location of the image. At step 824, the system may determine whether the location extracted from the geo-tag data is a valid location, and whether it is within a predetermined distance from the user's current location. Assuming that the user's preferences allow for his location to be used, if the server determines at step 824 that the location obtained from the photo's geo-tag data is valid but is not within a predetermined distance from the user's current location, the system may present an alert to the user at step 826 and give the user the option to use the geo-tag location data or some other location data. At step 828, if the user decides to disregard the alert, at step 832 the system may process the user's request and not use the geolocation extracted from the geo-tagged photo. Instead, the system will capture the user's current location, if allowed by the user as described above, and use this location for the post submitted by the user at step 812. If at step 828, the user decides to set the location of the post equal to the location and the media, this is done at step 830 where the location of the post is set equal to the location in the media, and the process proceeds to steps 832 and 812, where the user may add the post.

Returning to process step 814, if the user decides to submit a post without any media, at 834 the system may process the data to create a new post to the selected geolocation. At step 834, the system may consider the various parameters established by the user as well as automatically generated data, like geolocation, to create the new post. Metadata for the new post may include a text message, an image, video, audio and geolocation. The geolocation may be either the user's current location as determined by the user's device or the location extracted from a geo-tagged image. At step 814 the user may decide to cancel a post, in which case at step 836 the system will return the user to the screen (display) from which the user originally decided to and a post.

As may be appreciated from the foregoing, the invention affords a social network for communicating information among users that has significant advantages over known social networks. It is a particular advantage of a social network in accordance with the invention that users need not be members of any particular group, or have any relationship such as a “friend” or “follower” to other users in order to communicate information. It is further an advantage of the invention that communications among users are based upon a focal point or reference that comprises a physical geolocation, but that the actual physical location is not necessary for the communications. Rather, it sets a context for the communications. The geolocation allows users to quickly and easily locate and communicate information about things or points of interest using a physical location as a reference without requiring the information to have any particular relationship to the physical location, although it may. This is advantageous because many users of social networks are frequently interested in real-time information that is conveniently obtained by referencing to physical locations, as described above.

While the foregoing has been with respect to preferred embodiments the invention, it will be appreciated by those skilled in the art that changes to these embodiments may be made without departing from the principles and spirit the invention, the scope of which is defined by the appended claims.

1. A computer-implemented method for communicating information in a network comprising a server connected via the network to a plurality of user devices embodying processors, the method comprising:
receiving, at the server, geolocation data for creating a geolocation having a physical geographic location, said geolocation forming a reference for information that is related to said geolocation and to a topic of interest, said geolocation data comprising geographical coordinates defining said physical geographic location and defining user access privileges to said geolocation, there being other geolocation data at the server defining a plurality of other geolocations;
receiving, at the server, a request from a user to display on said user's device geolocations within a user-defined area;
determining, at the server, a set of one or more accessible geolocations within said user-defined area to which the user has access privileges by evaluating said data defining user access privileges to each of said set of geolocations with respect to said user;
providing display data to said user for displaying locations of said set of accessible geolocations on said user's device; and
upon receiving a request from the user to access a selected geolocation of said displayed accessible geolocations, granting by said server to said user access to said selected geolocation without requiring said user to have a predetermined location.

2. The method of claim 1, wherein said granting said user access to said selected geolocation comprises granting said user access privileges to view information from and post information to said selected geolocation.

3. The method of claim 1, wherein upon granting said user access to said selected geolocation, granting said user access to said information referenced by said selected geolocation without regard to a location of said user.

4. The method of claim 3, wherein said granting said user access further comprises granting said user access to post information comprising one or more of text and media to said selected geolocation.

5. The method of claim 4 wherein upon receiving user information comprising media that includes a geo-tagged location, determining said user's current location, and alerting said user if said current location is different from said geo-tagged location.

6. The method of claim 1, wherein said geolocation data for creating said other geolocations comprises data that defines a region bounded by a geofence about one of said other geolocations, and said method further comprises granting said user access to said one geolocation upon determining that such user has a location within said region.

7. The method of claim 6, where said determining said user location comprises querying said user device for location information.

8. The method of claim 1, wherein said data defining user access privileges comprises data making said geolocation private and requiring a user to have a predetermined attribute to have access privileges to said geolocation.

9. The method of claim 1, wherein said providing display data comprises providing data for displaying said locations, for displaying said user-defined area, and for displaying said user location on a map view on said user's device.

10. The method of claim 1, wherein said providing display data comprises filtering information referenced by said set of accessible geolocations using criteria provided by said user prior to providing said display data.

11. The method of claim 1 further comprising, upon receiving from a creator of said geolocation data for creating said geolocation at said physical geographical location, alerting said creator if there is another geolocation at another location near said physical geographical location, and giving said creator an option to use either said physical geographical location or said other location.

12. Non-transitory computer readable media embodying instructions for controlling the operation of one or more computers to communicate information in a network comprising a server connected to a plurality of user devices, comprising instructions for:
creating a geolocation having a physical geographic location using geolocation data, said geolocation forming a reference for information that is related to said geolocation and to a topic of interest, said geolocation data comprising geographical coordinates defining said physical geographic location and defining user access privileges to said geolocation, there being other geolocation data at the server defining a plurality of other geolocations;
processing a request from a user to display on said user's device geolocations located within a user-defined area;
determining a set of one or more accessible geolocations within said user-defined area to which the user has access privileges by evaluating said data defining user access privileges to each of said set of geolocations with respect to said user;
displaying locations of said set of accessible geolocations on said user's device; and
granting a request from the user to access a selected geolocation of said displayed accessible geolocations without requiring said user to have a predetermined location.

13. The non-transitory computer readable media of claim 12, wherein said granting said request comprises granting said user privileges to view information and to post information to said selected geolocation.

14. The non-transitory computer readable media of claim 13, whereas said granting comprises granting said user access to post one or more of text, images, or other media to said geolocation.

15. The non-transitory computer readable media of claim 14 further comprising, upon receiving media that includes geo-tagged location information, determining the user's current location, alerting the user if said geo-tagged location information is different from said current location.

16. The non-transitory computer readable media of claim 12 further comprising creating another geolocation having another physical location and referencing other information, providing a geofence defining a region around the other physical location of the other geolocation, determining a location of said user from said user's device, and granting said user access to said other geolocation upon determining that said user's location is within said region, otherwise denying access.

17. The non-transitory computer readable media of claim 12 wherein said data defining user access privileges comprises data that requires the user to have been granted access by a creator of said geolocation or the user to meet predetermined criteria.

18. The non-transitory computer readable media of claim 12, wherein said displaying comprises displaying said accessible geolocations and a location of the user on one of a map view or a list view on said user's device.
